(19) United States
(12) Patent Application Publication
(10) Pub. No.: US 2026/0078797 A1
(43) Pub. Date: Mar. 19, 2026

(54) COMPOUND CONNECTING ROD FOR INTERNAL COMBUSTION ENGINE EFFICIENCY

(71) Applicant: Natarajan Ramachandran, Huntersville, NC (US)

(72) Inventor: Natarajan Ramachandran, Huntersville, NC (US)

(21) Appl. No.: 19/184,145

(22) Filed: Apr. 21, 2025

Related U.S. Application Data
(60) Provisional application No. 63/695,885, filed on Sep. 18, 2024.

(51) Int. Cl. F16C 7/02

(52) U.S. Cl. CPC F16C 7/023

(57) ABSTRACT

A compound connecting rod for improving the efficiency of an internal combustion engine. The compound connecting rod includes a connecting rod, a connecting rod carrier, and a collapse blocker. During crankshaft rotation, the compound connecting rod undergoes a non-circular path that increases dwell time of a piston, reduces sidewall friction, and reduces secondary imbalance.

### CROSS-REFERENCE TO RELATED APPLICATIONS

This application claims the benefit and priority to U.S. Provisional Ser. No. 63/695,885 , filed on Sep. 18, 2024, the entire content of which is incorporated by reference herein in its entirety.

### BACKGROUND

Internal combustion engines lose a significant amount of energy when converting a fuel source to mechanical energy for powering a vehicle. Generally, only one-third of fuel energy is converted into mechanical energy and the remainder of the energy is lost to waste heat, friction of moving engine parts, or pumping air in and out of an internal combustion engine.

Improving the efficiency of internal combustion engines can result in (1) increasing the fuel economy of vehicles, (2) reducing the environmental impact of internal combustion engines, and (3) transitioning to renewable fuel options. Pistons, connecting rods, and cylindrical components within an internal combustion engine are critical to transforming chemical energy stored in fuel into mechanical energy for moving a vehicle.

### FIELD

The present disclosure is generally directed to connecting rods, more specifically to compound connecting rods for improving the power stroke efficiency of internal combustion engines.

### BRIEF SUMMARY OF THE PRESENT DISCLOSURE

In some embodiments, a compound connecting rod for an internal combustion engine is disclosed. The compound connecting rod is designed to improve the power stroke efficiency of an internal combustion engine by increasing dwell time of a piston, reducing sidewall friction, and reducing secondary imbalance.

In some embodiments, a system for improving the power stroke efficiency of an internal combustion engine is disclosed. The system includes a connecting rod carrier, a connecting rod, and a collapse blocker. In some embodiments, the connecting rod carrier is a unitary piece. Alternatively, the connecting rod carrier is two pieces. The connecting rod carrier is designed to pivot around a crank pin. The connecting rod carrier is connected to a pivot end of the connecting rod. The collapse blocker is positioned within the connecting rod carrier and is in contact with a first side of the connecting rod. In some embodiments, the system includes at least two collapse blockers, one on each side of the connecting rod.

The connecting rod pivots within the connecting rod carrier during crankshaft rotation. The connecting rod includes a first end and a second end. The first end is connected to a wrist pin of the piston. The second end is connected to a knuckle pin in the connecting rod carrier (“pivot end”). During crankshaft rotation, the connecting rod takes a non-circular path because the crank pin is not the pivot point of the connecting rod. The connecting rod's pivot point is positioned outside of the crank pin within the connecting rod carrier.

The collapse blocker prevents the connecting rod carrier from collapsing around the crank pin during crankshaft rotation. The collapse blocker is in contact with the connecting rod within the connecting rod carrier at all times. The collapse blocker can pivot around its pivot point within the connecting rod carrier. During crankshaft rotation, the connecting rod in combination with the collapse blocker applies distributed forces upon the connecting rod carrier to prevent the connecting rod carrier from collapsing around the crank pin.

Advantageously, between about 0 degrees and about 180 degrees of crankshaft rotation, the dwell time of piston is increased because the connecting rod's pivot point transitions from outside of the crank pin at about 0 degrees to inside of crank pin at about 180 degrees, resulting in the non-circular path of the connecting rod.

Yet another advantage of the present disclosure includes the reduced side wall friction during crankshaft rotation. The side wall friction is reduced because the connecting rod's pivot end lies outside of the crank pin positioned within the connecting rod carrier. This creates a non-rigid connection between the piston and crank pin, resulting in a reduced angle between the piston and the connecting rod carrier. The non-circular path taken by the connecting rod during crankshaft rotation results in a reduction of the acceleration and deceleration forces acting upon the piston, thereby reducing secondary imbalance.

In some embodiments, at least two connecting rods are connected to a connecting rod carrier with an appropriate degree of separation. For example, and without limitation, in some embodiments, two cylinders of a 4-stroke engine have 180 degrees of separation.

In at least one embodiment of the present disclosure, an internal combustion engine including a compound connecting rod is disclosed. The compound connecting rod is connected to a crank on a crankshaft and at least one piston.

In at least one aspect of the present disclosure, a compound connecting rod is disclosed. The compound connecting rod includes a connecting rod, a connecting rod carrier, and a collapse blocker. A first end of the connecting rod can be attached to a piston. A second end of the connecting rod can be pivotably connected to a connecting rod carrier. A collapse blocker can be positioned in the connecting rod carrier. The collapse blocker can be in contact with the second end of the connecting rod. During crankshaft rotation, the connecting rod can follow a non-circular path.

In at least one aspect of the present disclosure, during crankshaft rotation, the collapse blocker and the connecting rod can prevent the connecting rod carrier from collapsing about a crank pin.

In at least one aspect of the present disclosure, during crankshaft rotation, the dwell time of the piston is increased.

In at least one aspect of the present disclosure, during crankshaft rotation, an angle between a cylinder wall and the connecting rod carrier is reduced.

In at least one aspect of the present disclosure, during crankshaft rotation, the second end of the connecting rod undergoes an elliptical path.

In at least one aspect of the present disclosure, a compound connecting rod including at least two collapse blockers is disclosed. A second collapse blocker can be in contact with the second end of the connecting rod. The second collapse blocker can be in contact with an opposite side of the second end of the connecting rod relative to the collapse blocker.

In at least one aspect of the present disclosure, the collapse blocker is in contact with at least two walls of the connecting rod carrier.

In at least one aspect of the present disclosure, the connecting rod carrier is substantially circular.

In at least one aspect of the present disclosure, the collapse blocker conforms to a shape of the second end of the connecting rod.

In at least one aspect of the present disclosure, a compound connecting rod is disclosed. The compound connecting rod can include a connecting rod, a connecting rod carrier, and a collapse blocker. A first end of the connecting rod can be attached to a piston. A second end of the connecting rod can be pivotably connected to a connecting rod carrier. The collapse blocker can be positioned in the connecting rod carrier. The collapse blocker can be in contact with the second end of the connecting rod. During crankshaft rotation, the connecting rod can follow a non-circular path. During crankshaft rotation, the collapse blocker and the connecting rod can prevent the connecting rod carrier from collapsing about a crank pin.

In at least one aspect of the present disclosure, the collapse blocker is in contact with at least two walls of the connecting rod carrier. In at least one aspect of the present disclosure, during crankshaft rotation, the dwell time of the piston is increased. In at least one aspect of the present disclosure, during crankshaft rotation, an angle between a cylinder wall and the connecting rod carrier is reduced. In at least one aspect of the present disclosure, during crankshaft rotation, the second end of the connecting rod undergoes an elliptical path. In at least one aspect of the present disclosure, the compound connecting rod can include a second collapse blocker. The second collapse blocker may be in contact with the second end of the connecting rod. The second collapse blocker can be in contact with the second end of the connecting rod on an opposite side of the second end of the connecting rod relative to the first collapse blocker. In at least one aspect of the present disclosure, the collapse blocker is in contact with at least two walls of the connecting rod carrier. In at least one aspect of the present disclosure, the connecting rod carrier is substantially circular, the collapse blocker conforms to a shape of the second end of the connecting rod. In at least one aspect of the present disclosure, the collapse blocker conforms to a shape of the second end of the connecting rod. The collapse blocker can apply a counterforce to the second end of the connecting rod during crankshaft rotation. In at least one aspect of the present disclosure, the connecting rod carrier is substantially circular. The second end of the connecting rod includes a curvature. The collapse blocker can include a shape that conforms to the curvature of the second end of the connecting rod.

### BRIEF DESCRIPTION OF THE DRAWINGS

The embodiments illustrated, described, and discussed herein are illustrative of the present disclosure. As these embodiments of the present disclosure are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present disclosure, and through which these teachings have advanced the art, are considered to be within the spirit and scope of the present disclosure. Hence, these descriptions and drawings should not be considered in a limiting sense, as it is understood that the present disclosure is in no way limited to only the embodiments illustrated.

FIG. 1A depicts a compound connecting rod of an internal combustion engine according to at least one embodiment of the present disclosure.

FIG. 1B depicts an exploded view of the compound connecting rod of the internal combustion engine shown in FIG. 1A.

FIG. 1C illustrates a force diagram of a compound connecting rod during crankshaft rotation according to at least one embodiment of the present disclosure.

FIG. 1D illustrates a comparison of movement of the compound connecting rod (non-circular) during crankshaft rotation (circular).

FIG. 2 illustrates a compound connecting rod of an internal combustion engine according to at least one embodiment of the present disclosure.

FIG. 3 illustrates a compound connecting rod system of an internal combustion engine according to at least one embodiment of the present disclosure.

FIG. 4 illustrates a collapse blocker including a notch according to one embodiment of the present disclosure.

FIG. 5 illustrates an exploded view of an engine crankshaft according to at least one embodiment of the present disclosure.

FIG. 6 illustrates a portion of an internal combustion engine including a compound connecting rod according to at least one embodiment of the present disclosure.

### DETAILED DESCRIPTION

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a,” “an,” and “the” refer to “one or more” when used in the subject specification, including the claims. Thus, for example, reference to “a device” can include a plurality of such devices, and so forth.

Unless otherwise indicated, all numbers expressing quantities of components, conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

During an intake stroke, a piston moves downward to create a vacuum (e.g., fuel-air mixture) within a cylinder. As the piston ascends during a compression stroke, the vacuum is compressed, thereby increasing the pressure and temperature within the cylinder. At an apex of the stroke, the pressure is at a maximum and a spark plug ignites the fuel-air mixture to initiate combustion. The combustion forces the piston down (e.g., power stroke) and generates the mechanical energy that is transferred to the internal combustion crankshaft.

The task of transferring the mechanical energy from the piston to the crankshaft relies on the connecting rods. As the piston moves down during the power stroke, the connecting rod pivots around the piston pin and transmits the mechanical force from the combustion process to the crankshaft, thereby powering a vehicle.

During each rotation of the crankshaft, a connecting rod is subject to forces including (1) shear forces due to the angle between the piston and crankpin, (2) compression forces as the piston moves downwards, and (3) tensile forces as the piston moves upward. The angle of the connecting rod is proportional to the amount of force exerted on the piston through the connecting rod by the crankshaft. This force can cause damage and warping of the cylinders, thereby reducing engine performance. Therefore, connecting rods need to be durable to prevent impacting the engine performance.

Other factors that impact the performance and efficiency of an internal combustion engine include (1) stroke length, (2) length of connecting rods, (3) stroke ratio, and (4) connecting rod angularity. Stroke length is the distance a piston travels between its lowest and highest points within the cylinder. Longer stroke lengths generate higher torque at lower revolutions per minute (RPMs), thereby ideal for substantial power (e.g., towing). Internal combustion engines with shorter stroke lengths are optimal for higher horsepower applications (e.g., acceleration).

Longer connecting rods reduce friction and improve engine efficiency. The stroke ratio of an engine is affected by the connecting rod length. The stroke ratio is a ratio of the stroke length (distance a piston travels) to the bore diameter (diameter of the cylinder). When the connecting rod length increases, the stroke ratio decreases. A shorter connecting rod decreases the piston's travel distance for a bore diameter, thereby lowering piston speeds and reducing frictional losses.

Rod angularity is a connecting rod's angle relative to the crankshaft's centerline during an internal combustion engine's rotation. A shorter connecting rod increases the angularity and a longer connecting rod reduces the angularity. The rod angularity can minimize side loading on a piston, piston rings, and cylinder walls, which improves the reliability of engine performance.

In addition to the engine stroke ratio and rod angularity, the connecting rod length further affects an engine's piston dwell time at TDC and BDC, influences valve timing, compression ratio, and the intake and exhaust processes. This impacts an engine's power delivery, fuel efficiency, and other performance aspects.

In some embodiments, a compound connecting rod for an internal combustion engine is disclosed. The compound connecting rod is designed to improve power stroke efficiency of the internal combustion engine by increasing dwell time of a piston. The compound connecting rod increases the dwell time of a piston between top dead center (TDC) and bottom dead center (BDC). Additionally, the compound connecting rod reduces sidewall friction and reduces secondary imbalance during crankshaft rotation. In some embodiments, the compound connecting rod is used in at least one of a 4-stroke otto cycle, a 2-stroke otto cycle, or a 4-stroke diesel cycle.

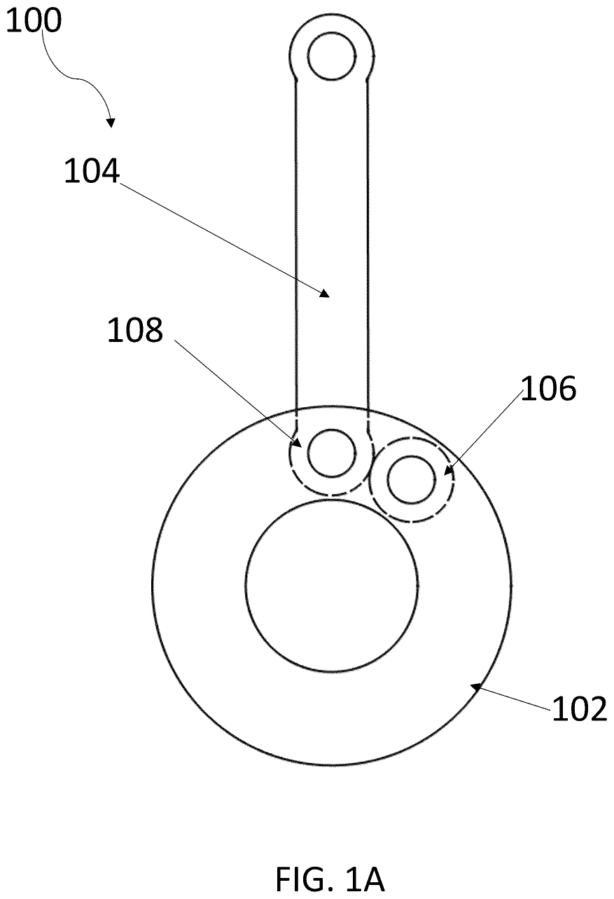

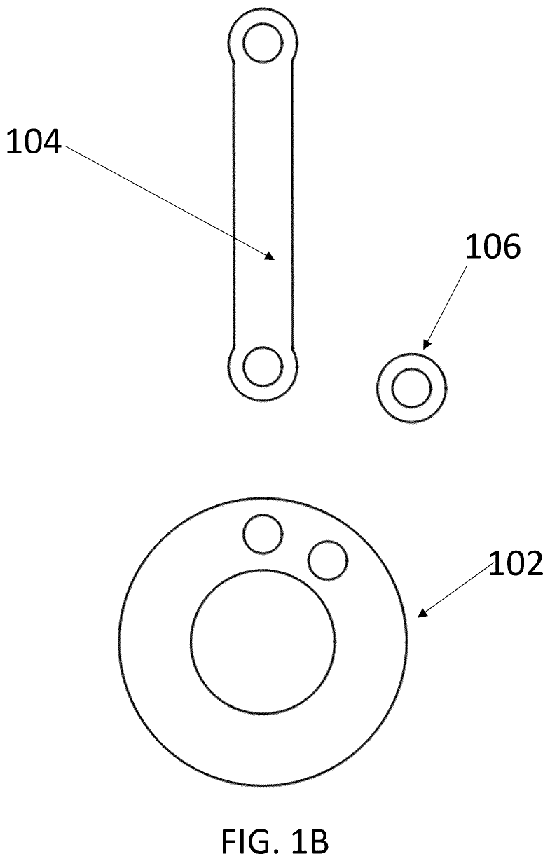

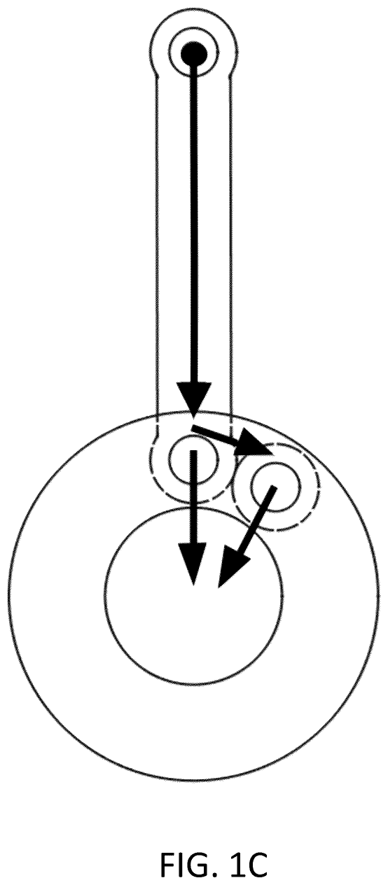

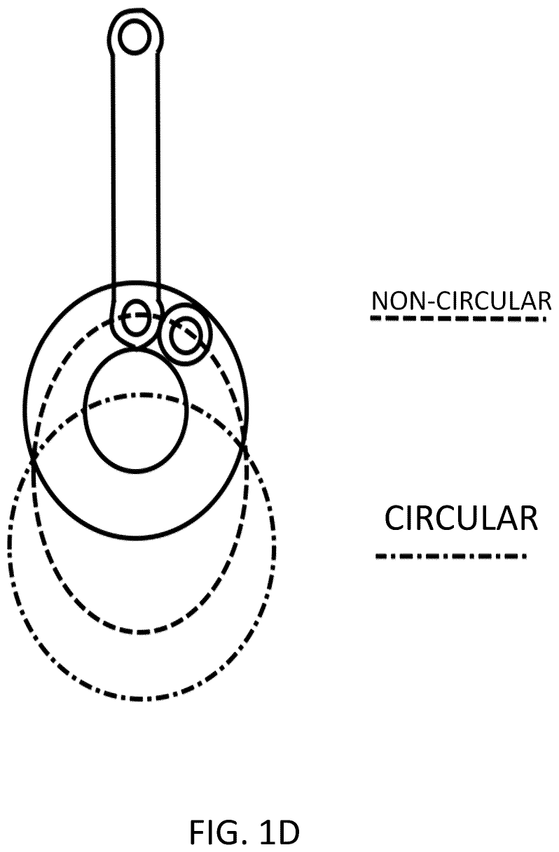

In some embodiments, as shown in FIG. 1A, a compound connecting rod for an internal combustion engine is disclosed. The compound connecting rod 100 includes a connecting rod carrier 102, a connecting rod 104, and a collapse blocker 106. The connecting rod carrier pivots around a crank pin. A pivot end 108 of the connecting rod is connected to the connecting rod carrier. In some embodiments, at least two connecting rods are connected to the connecting rod carrier. The collapse blocker 106 is positioned within the connecting carrier and is in contact with the connecting rod. In some embodiments, the compound connecting rod includes at least two collapse blockers, each in contact with a side of the connecting rod. FIG. 1B illustrates an exploded view of the compound connecting rod shown in FIG. 1A. FIG. 1C illustrates a force diagram of the compound connecting rod during crankshaft rotation.

The connecting rod is designed to pivot within the connecting rod carrier during crankshaft rotation. A first end of the connecting rod is connected to a wrist pin of a piston. A second end of the connecting rod is connected to a knuckle pin in the connecting rod carrier (pivot end). During crankshaft rotation, as shown in FIG. 1D, the connecting rod follows a non-circular path because the crank pin is not the connecting rod's pivot point. The connecting rod's pivot point is positioned outside of the crank pin within the connecting rod carrier.

The collapse blocker prevents the connecting rod carrier from collapsing around the crank pin during crankshaft rotation. The collapse blocker maintains contact with the connecting rod throughout crankshaft rotation. The collapse blocker can pivot around its pivot point within the connecting rod carrier. During crankshaft rotation, the connecting rod and the collapse blocker distribute forces acting upon the connecting rod carrier with the crank pin as a pivot point. Advantageously, the connecting rod and collapse blocker prevent the connecting rod carrier from collapsing around the crank pin.

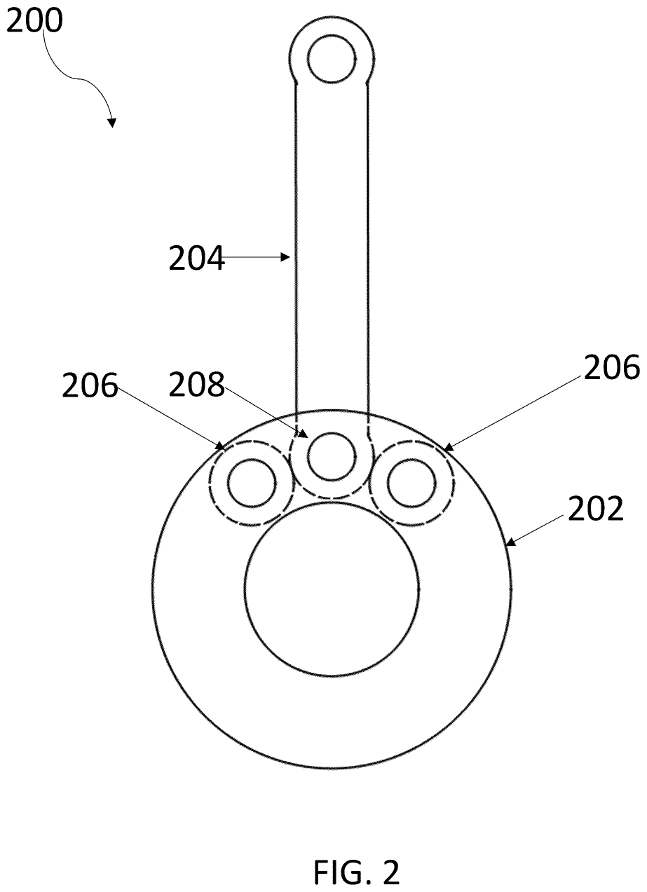

In some embodiments, the present disclosure includes at least two collapse blockers. FIG. 2 illustrates a compound connecting rod according to at least one embodiment of the present disclosure. The compound connecting rod includes a connecting rod carrier 202, a connecting rod 204, and at least two collapse blockers 206. The connecting rod carrier pivots around a crank pin. A pivot end 208 of the connecting rod is connected to the connecting rod carrier 202. In some embodiments, at least two connecting rods are connected to the connecting rod carrier. The at least two collapse blockers 206 are positioned within the connecting carrier and in contact with the connecting rod. The at least two collapse blockers can include a collapse blocker positioned on opposite sides of the connecting rod 204.

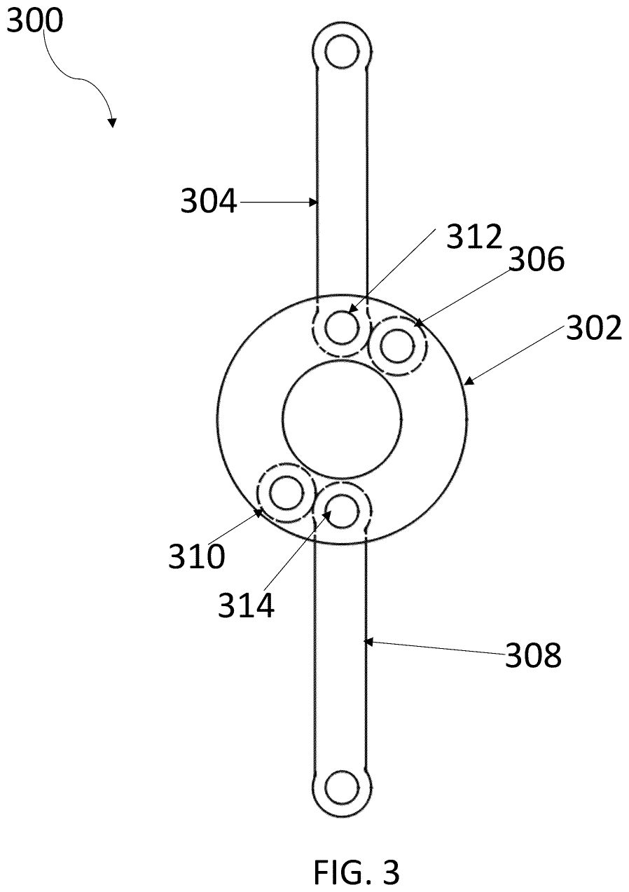

FIG. 3 illustrates a compound connecting rod system according to at least one embodiment of the present disclosure. The compound connecting rod system 300 includes a connecting rod carrier 302, a first connecting rod 304, a first collapse blocker 306, a second connecting rod 308, and a second collapse blocker 310. The connecting rod carrier pivots around a crank pin. A pivot end 312 of the first connecting rod 304 is connected to the connecting rod carrier 302. The at least one collapse blocker 306 is positioned within the connecting rod carrier and is in contact with a corresponding connecting rod. A pivot end 314 of the second connecting rod 308 is connected to the connecting rod carrier 302. The second collapse blocker 310 is positioned within the connecting rod carrier and is in contact with a corresponding connecting rod.

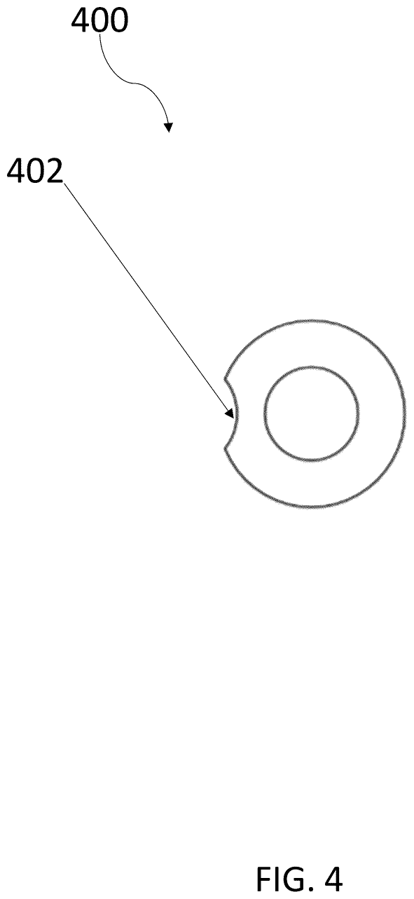

In some embodiments, as shown in FIG. 4, the collapse blocker 400 includes at least one notch 402 operable to increase surface contact with the connecting rod. The at least one notch 402 conforms to the contour of the connecting rod.

During crankshaft rotation between 0 to 180 degrees, the dwell time of the piston is higher because of the non-circular path of the connecting rod due to the pivot end of the connecting rod transitioning from a larger outer diameter at 0 degrees to a smaller inner diameter at 180 degrees. The non-circular path further reduces the acceleration/deceleration forces experienced by the piston and as a result, reduces secondary imbalance. Between 180 to 360 degrees of crankshaft rotation, the connecting rod's pivot point transitions from inside of the crank pin at 180 degrees to outside of the crank pin at 360 degrees.

Additionally, side wall friction is reduced during crankshaft rotation because the pivot point of the pivot end of the connecting rod is outside of the crank pin within the connecting rod carrier. This creates a non-rigid connection between the piston and crank pin and reduces the angle between the piston and connecting rod carrier.

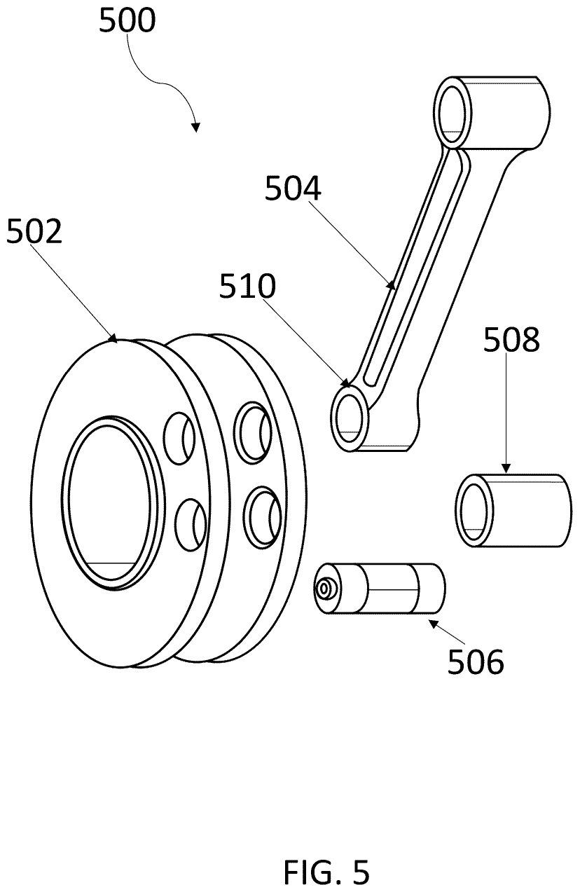

FIG. 5 illustrates an exploded view of an engine crankshaft including a compound connecting rod according to at least one embodiment of the present disclosure. The engine crankshaft 500 includes a connecting rod carrier 502, a connecting rod 504, a knuckle pin 506, and a collapse blocker 508. The collapse blocker 508 can be positioned within the connecting rod carrier 502 such that the collapse blocker 508 is in contact with a side of a pivot end 510 of the connecting rod 504. In some aspects of the present disclosure, the engine crankshaft may include a plurality of connecting rods. Each connecting rod of the plurality of connecting rods can include a corresponding collapse blocker within a corresponding connecting rod carrier. The collapse blocker includes a shape conformed to a shape and size of the pivot end of the connecting rod.

Due to the circular shape of the connecting rod carrier, the pivot end of the connecting rod and the collapse blocker act at the pivot point (crankpin) of the connecting rod carrier during crankshaft rotation. When force is applied to the pivot end, it is also transferred to collapse blocker, resulting in the force to be applied to both sides of the crankpin of the connecting rod carrier. Advantageously, this prevents the connecting rod carrier from collapsing around the crank pin.

In at least one aspect of the present disclosure, the connecting rod includes an articulated rod design for a radial engine. The connecting rod and the collapse blocker may include forged steel, billet steel, or cast steel. The connecting rod and collapse blocker may include a finish and/or coating on an exterior surface to reduce friction. Bushing, bearings, (e.g., thrust), and/or lubrication can be used as necessary to reduce friction and improve movement. In at least one aspect of the present disclosure, the pivot end of the connecting rod is larger than a wrist pin.

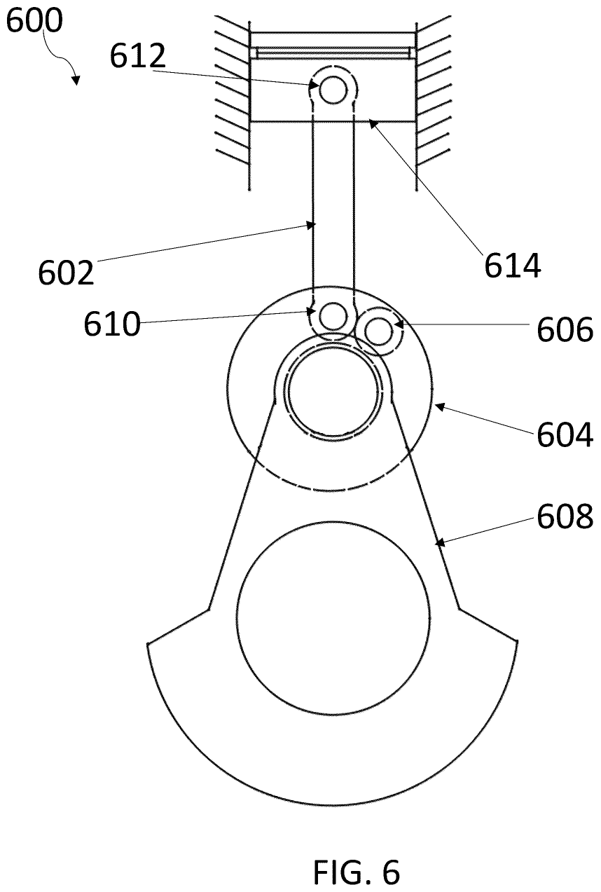

FIG. 6 illustrates a portion of an internal combustion engine including a compound connecting rod according to at least one embodiment of the present disclosure. The compound connecting rod includes a connecting rod 602, a connecting rod carrier 604, and a collapse blocker 606. The connecting rod carrier pivots around a crank pin of a crankshaft 608. A pivot end 610 of the connecting rod is connected to the connecting rod carrier. A second end 612 of the connecting rod is connected to a piston 614. In some embodiments, at least two connecting rods are connected to the connecting rod carrier. The collapse blocker 606 is positioned within the connecting carrier and is in contact with the connecting rod. In some embodiments, the compound connecting rod includes at least two collapse blockers, each in contact with a side of the connecting rod.

The connecting rod is designed to pivot within the connecting rod carrier during crankshaft rotation. A first end of the connecting rod is connected to a wrist pin of a piston 614. A second end of the connecting rod is connected to a knuckle pin in the connecting rod carrier (pivot end). During crankshaft rotation, the connecting rod follows a non-circular path because the crank pin is not the connecting rod's pivot point. The connecting rod's pivot point is positioned outside of the crank pin within the connecting rod carrier.

The collapse blocker prevents the connecting rod carrier from collapsing around the crank pin during crankshaft rotation. The collapse blocker maintains contact with the connecting rod throughout crankshaft rotation. The collapse blocker can pivot around its pivot point within the connecting rod carrier. During crankshaft rotation, the connecting rod and the collapse blocker distribute forces acting upon the connecting rod carrier with the crank pin as a pivot point. Advantageously, the connecting rod and collapse blocker prevent the connecting rod carrier from collapsing around the crank pin.

The corresponding structures, materials, acts, and equivalents of all means or step plus function elements in the claims below are intended to include any structure, material, or act for performing the function in combination with other claimed elements as specifically claimed.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A compound connecting rod comprising:
a connecting rod;
a connecting rod carrier; and
a collapse blocker;
wherein a first end of the connecting rod is attached to a piston;
wherein a second end of the connecting rod is pivotably connected to a connecting rod carrier;
wherein the collapse blocker is positioned in the connecting rod carrier,
wherein the collapse blocker is in contact with the second end of the connecting rod; and
wherein, during crankshaft rotation, the connecting rod undergoes a non-circular path.

2. The compound connecting rod of claim 1, wherein, during crankshaft rotation, the collapse blocker and the connecting rod prevent the connecting rod carrier from collapsing about a crank pin.

3. The compound connecting rod of claim 1, wherein, during crankshaft rotation, the dwell time of the piston is increased.

4. The compound connecting rod of claim 1, wherein, during crankshaft rotation, an angle between a cylinder wall and the connecting rod carrier is reduced.

5. The compound connecting rod of claim 1, wherein, during crankshaft rotation, the second end of the connecting rod undergoes an elliptical path.

6. The compound connecting rod of claim 1 further comprising a second collapse blocker, wherein the second collapse blocker is in contact with the second end of the connecting rod, wherein the second collapse blocker is in contact with an opposite side of the second end of the connecting rod relative to the collapse blocker.

7. The compound connecting rod of claim 1, wherein the collapse blocker is in contact with at least two walls of the connecting rod carrier.

8. The compound connecting rod of claim 1, wherein the connecting rod carrier is substantially circular.

9. The compound connecting rod of claim 1, wherein the collapse blocker conforms to a shape of the second end of the connecting rod.

10. A compound connecting rod comprising:
a connecting rod;
a connecting rod carrier; and
a collapse blocker;
wherein a first end of the connecting rod is attached to a piston;
wherein a second end of the connecting rod is pivotably connected to a connecting rod carrier;
wherein the collapse blocker is positioned in the connecting rod carrier,
wherein the collapse blocker is in contact with the second end of the connecting rod;
wherein, during crankshaft rotation, the connecting rod follows a non-circular path; and
wherein, during crankshaft rotation, the collapse blocker and the connecting rod prevent the connecting rod carrier from collapsing about a crank pin.

11. The compound connecting rod of claim 10, wherein the collapse blocker is in contact with at least two walls of the connecting rod carrier.

12. The compound connecting rod of claim 10, wherein, during crankshaft rotation, the dwell time of the piston is increased.

13. The compound connecting rod of claim 10, wherein, during crankshaft rotation, an angle between a cylinder wall and the connecting rod carrier is reduced.

14. The compound connecting rod of claim 10, wherein, during crankshaft rotation, the second end of the connecting rod undergoes an elliptical path.

15. The compound connecting rod of claim 10 further comprising a second collapse blocker, wherein the second collapse blocker is in contact with the second end of the connecting rod, wherein the second collapse blocker is in contact with an opposite side of the second end of the connecting rod relative to the collapse blocker.

16. The compound connecting rod of claim 10, wherein the collapse blocker is in contact with at least two walls of the connecting rod carrier.

17. The compound connecting rod of claim 10, wherein the connecting rod carrier is substantially circular.

18. The compound connecting rod of claim 10, wherein the collapse blocker conforms to a shape of the second end of the connecting rod.

19. The compound connecting rod of claim 10, wherein the collapse blocker conforms to a shape of the second end of the connecting rod, wherein the collapse blocker is configured to apply a counterforce to the second end of the connecting rod during crankshaft rotation.

20. The compound connecting rod of claim 10, wherein the connecting rod carrier is substantially circular, wherein the second end of the connecting rod includes a curvature, wherein the collapse blocker includes a shape that conforms to the curvature of the second end of the connecting rod.
